(19) United States
(12) Patent Application Publication
(10) Pub. No.: US 2007/0144911 A1
(43) Pub. Date: Jun. 28, 2007

(54) Apparatus and process for the sanitization of water

(76) Inventor: Vincent J. Pulis, Mississauga (CA)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/451,626

(22) Filed: Jun. 9, 2006

Related U.S. Application Data
(60) Provisional application No. 60/688,835, filed on Jun. 9, 2005.

(51) Int. Cl. C02F 1/46

(52) U.S. Cl. 204/660; 210/243; 204/672

(57) ABSTRACT

An apparatus for sanitizing water, comprising a pump, a plurality of cells, a conduit system connecting the plurality of the cells with each other and with the pump; and a valve system at the conduit system for directing the flow of water through the conduit system. Each cell comprises an inlet and an outlet for a flow of water, an electrically-conductive tubing housed in the cell and connecting with the inlet with the outlet; and an electromagnetic pulsing device connected to the tubing.

### RELATED APPLICATIONS

This application claims the benefit of U.S. Provisional Application No. 60/688,835, filed on Jun. 9, 2005, the entire teaching of which is incorporated by reference.

### BACKGROUND OF THE INVENTION

There is a need for disinfection and sanitization of a large number of types of bodies of water, including, for example, cooling water systems, pasteurizing systems, waste water effluents, pulp and paper mills, swimming pools, hot tubs, spas, fountains, water attractions, oil fields, air washers, fire reservoirs, and evaporative condensers. In these bodies of water, the growth of bacteria, fungi, algae and slime are undesirable and, sometimes, detrimental. Unfortunately, these systems often have ideal conditions for growth of these organisms. Many methods for preventing and killing such growths have been devised.

Currently, the most widely used purification treatment in the water sanitization industry is ozone. This method, however, suffers a drawback because ozone converts a common element found in most ground water, bromide, to a potentially harmful by-product, bromate, which is a known carcinogen.

Therefore, there is a need for improved methods and apparatus that can sanitize water without a use of ozone.

### SUMMARY OF THE INVENTION

The invention is directed to an apparatus and a method for sanitizing water.

In one embodiment, the apparatus for sanitizing water comprises a pump, a plurality of cells, a conduit system connecting the plurality of the cells with each other and with the pump, and a valve system at the conduit system for directing the flow of water through the conduit system. Furthermore, each cell comprises an inlet and an outlet for a flow of water, an electrically-conductive tubing housed in the cell and connecting with the inlet with the outlet, and an electromagnetic pulsing device connected to the tubing.

In another embodiment, the method includes the steps of introducing a flow of water to a plurality of cells that are housed in a water sanitizing apparatus, actuating the sanitizing apparatus to administer electromagnetic pulses, and exposing the flow of water to the electromagnetic pulses.

There is an immediate global market for the water sanitization system to treat and purify drinking water. Today, the most widely used purification treatment in the bottled water industry is ozone. There are limitations to use of ozone. Ozone converts a common element found in most ground water, bromide, to a potentially harmful by-product, bromate—a known carcinogenic. Regulatory agencies in both North America and Europe have begun to tighten guidelines, and are limiting the amount of bromate allowable, for example, in bottled drinking waters. Many water sources far exceed the recommended guidelines; therefore, water sanitizing entities such as bottled water producers are forced to find alternative treatment methods that do not cause bromate conversion. The water sanitization system described in the present invention purifies water by administering the water with electromagnetic pulses, without bromate conversion, and can thus replace or reduce ozone use in the water industry.

### BRIEF DESCRIPTION OF THE DRAWINGS

FIG. 1 shows an apparatus 110 as one embodiment of the invention for sanitizing water.

FIG. 2 shows a cell 210 which can be employed in apparatus 110.

FIG. 3 shows a schematic view of an electricity conducting insert 214 viewed from a direction indicated by arrow 224.

### DETAILED DESCRIPTION OF THE INVENTION

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

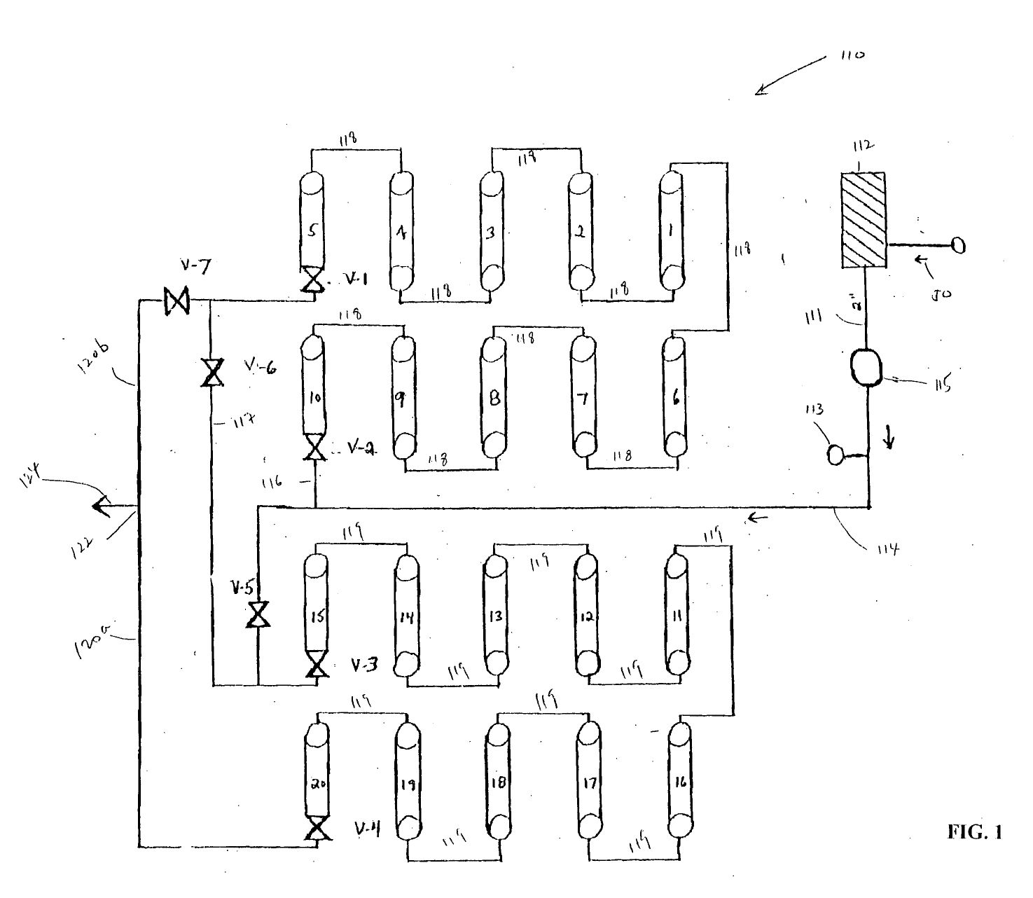

FIG. 1 shows apparatus 110 as one embodiment of the invention for sanitizing water. In this embodiment, water, e.g., pre-filtered municipal treated water, spring water, and the like, is directed to pump 112 as indicated by arrow 50, via an inlet such as a 2 inch triclamp suction connection on the pump. Pump control, speeds, pressure and monitoring are processed and adjusted internally with a controller. A suitable controller can be a Programmable Logic Controller (PLC).

Upon an activation of pump 112, water first enters conduit 111 (pump discharge piping), where the diameter of the conduit is smaller than other conduits in apparatus 110. A typical diameter for the conduit 111 is about 3 cm to 8 cm, preferably about 5 cm. All the conduits of the invention are constructed with rigid tubing, e.g., polyvinyl chloride. Flowmeter 115 can be attached to monitor the speed of the flow of water into main conduit 114. Main conduit 114, which connects with conduit 111 at one end, is fitted with a larger diameter piping, typically about 8 cm, compared to that of conduit 111. The flow of water is introduced to conduit 114, which directs the flow of water towards the cells. Off main conduit 114, the water is further directed via branching conduits, and enters a cell or cells depending on the status of valves. The pressure of the flow of water is monitored by pressure gauge 113.

Apparatus 110 includes multiple valves for directing the flow of water through the conduit system. Depending on the status of the valves, apparatus 110 can run the flow of water in different modes.

In one embodiment, as shown in FIG. 1, for example, a series mode can be implemented when the valve status are shown as below:

V-1 [OPEN]

V-2 [OPEN]

V-3 [OPEN]

V-4 [OPEN]

V-5 [CLOSED]

V-6 [OPEN]

V-7 [CLOSED].

In the series mode according to FIG. 1, as valve V-5 is closed, the water first enters cell 10 via conduit 116 and goes sequentially through the subsequent cells, starting from cell 9 to cell 5 via conduit 118. After passing through cell 5, the flow is then directed to cell 15 via conduit 117 and enters cell 15 because valve V-7 is closed. Again, the flow of water goes sequentially through the subsequent cells, starting from cell 14 to cell 20 via conduit 119. After passing cell 20, via conduit 120a and to outlet 122, the water, now sanitized, exits apparatus 110 through the outlet 122, as indicated by arrow 124 and is ready for safe consumption and packaging. As the water passes through these cells, each cell administers the water electromagnetic pulses. Resulting electric and magnetic fields may couple with electrical/electronic systems to produce damaging current and voltage surges against the bacteria, thereby sanitizing the water without using ozone. The details on the structure of the cell will be described below.

In another embodiment, as shown in FIG. 1, for example, a series-parallel mode can be achieved when the valve status are shown as below:

V-1 [OPEN]

V-2 [OPEN]

V-3 [OPEN]

V-4 [OPEN]

V-5 [OPEN]

V-6 [CLOSED]

V-7 [OPEN].

Under the series-parallel mode, as valve V-5 is open and valve V-6 is closed, the flow of water is divided into two separate flows. A first flow is directed to cell 10 off main conduit 114 and via conduit 116 and a second flow is directed to cell 15 almost simultaneously via conduit 117. The first flow and second flow go through sequentially the respective subsequent cells, starting from cell 9 to cell 5 and from cell 14 to cell 20. Passing through cell 5, the first flow reaches outlet 122 via conduit 120b. Conversely, the second flow passes through cell 20 and is directed to outlet 122 via conduit 120a.

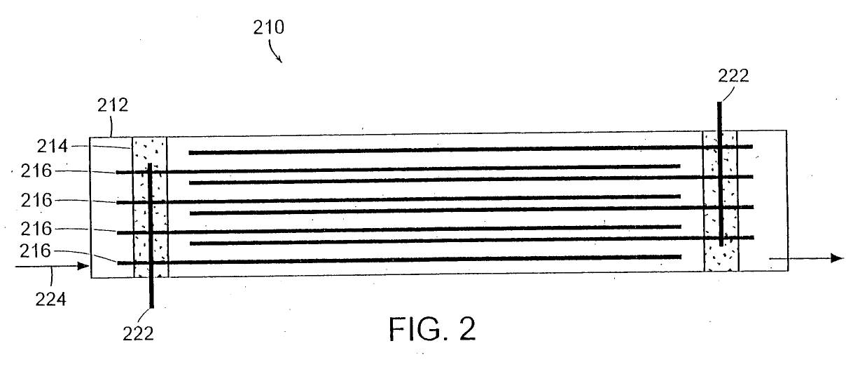

FIG. 2 shows a cell 200 singularly. The cell can be constructed with rigid tubing 212, e.g., polyvinyl chloride (PVC) tubing, about 2 to 25 cm inside diameter and about 50 to 250 cm long, preferably about 5 to 10 cm inside diameter and about 100 to 150 cm long, more preferably about 7 to 8 cm inside diameter and about 110 to 120 cm long. A rigid insulating insert 214, e.g., made of PVC, is employed to hold the electrode plates 216. Electrode plates 216 can be about 1 cm to 10 cm wide, about 50 to 150 cm long titanium plates, preferably about 5 to 6 cm wide, about 90 to 100 cm long titanium plates. Furthermore, each of the plates can be covered with about 60 to 120 micro-ohms coating of platinum, preferably about 90 to 100 micro-ohms coating of platinum. Plates 216 can be held by insert 214 in 2 sets (for positive and negative) of a 4 plate assembly each as shown. Plates 216 can be spaced at about 2 to 10 mm between the two sets, preferably 6 to 7 mm. Each set can be terminated with a 316 stainless steel stud 222 that exits cell 210. Each cell includes an inlet and an outlet for water to enter and to exit, respectively (not shown). Water is directed through each cell, perpendicular to plates 216, in between the plates 216, in a direction indicated by arrow 224. The water flow rate through each cell typically is adjusted to be laminar and can be calibrated with a non-invasive flow meter and logged. Lastly, each cell can be removed for maintenance and inspection.

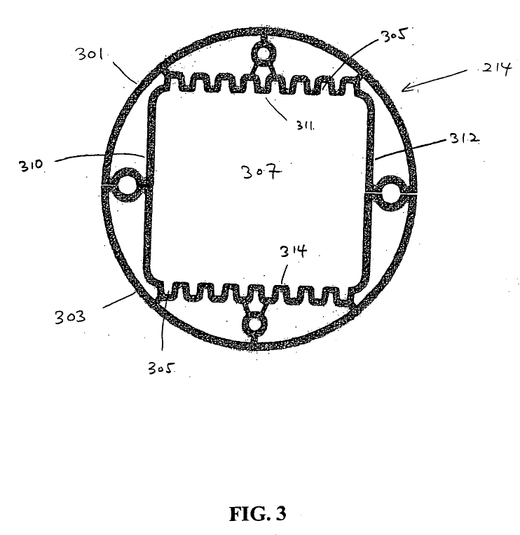

Electrically-conductive insert 214 is further described in FIG. 3. In a preferred embodiment, the cell design construction can include an insert that consists of uniquely milled PVC. Typically, insert 214 includes two half section 301 and 303. These two half sections allow a concentric area 307 to enclose each set of a 4 plate assembly of anode and cathode. The half sections 301 and 303 of insert 214 are centered and kept in tolerance specifications by four wall spacer supports 310, 311, 312 and 314 that are attached and formed as part of each half of insert 214. Insert 214 further includes a plurality of ribs 305 for accommodating the plates insertion.

As part of the cell assembly, end sectional caps (not shown), typically ones with ultra high molecular weight, are used to secure insert 214 in place. The plate assemblies are designed and machined to allow the complete vertical assembly to automatically provide a complete drain of the cells.

Individual cell wiring is separately installed to all cells. An example of circuitry (not shown) for the cells can be described as below. An isolation transformer (k-8) steps (about 90 KVA) down the primary about 500 to 700 volts (preferably, 600 volts), 3-phase from a power supply to a multiple tap secondary of 10-20 volts alternating current (AC), 3-phase. The power source can include a distribution and PLC and an output device such as a man-machine interface screen to reporting the operation of the cells. The 3-phase AC secondary is fed into a resistor such type as a thyristor, for example, a 500 amp three phase thyristor direct current (DC) converter for conversion to DC. In one embodiment, the thyristor includes twelve silicon controlled rectifiers arranged as a four quadrant operation. The thyristor is employed to excite the cells with six silicon controlled rectifiers (SCR) and a four quadrant circuit arrangement. Electromagnetic pulsing by the cells is gate-triggered into conduction by firing boards. Reaction output load is fed into diversionary board. Cell amps and voltages are ramped up and down as a function of time to excite the cell electrode plates. Alternation of DC power can be reversed to the cells about, for example, every 30 minutes. Currents are first applied at, for example, about 5.0 amps DC per cell at voltages that are relevant to the conductivity of the incoming supply water. Time ramping begins and continues until about 10 amps per cell can be maintained.

A controller is in communication with the circuitry. For example, a PLC controller PID instruction controls a closed loop using inputs from an analog input modules and providing an output to an analog output module as a response to effectively hold a process variable at a desired set point for electromagnetic pulsing.

Furthermore, the controller can be used in conjunction with other sensors. For example, a closed-loop plc control is utilized with an OH and H₂O₂ sensors. These sensors are used in a feedback loop. In utilizing this loop, apparatus 110 is not dependant on water chemical composition. The PLC and software monitor and control these loops.

The invention is illustrated with the following exemplification, which is not intended to be limiting in any way.

### EXEMPLIFICATION

A spiked water challenge test was conducted. On day 1, a challenge water spiked with Pseudomonasfluorescens was tested followed by low level ozonation (<0.02 ppm). The challenge water was also spiked with a high level of bromide (0.122 ppm). Another similar test was conducted. The challenge water contained 0.132 ppm of bromide and spiked with E. coli. Again, the water was processed and a small amount of ozone was added in a consecutive process step.

The data from both challenge tests indicated that apparatus 110 killed both of the spiked microbes and bromate formation was significantly lower than seen with systems that only ozone the product for disinfection.

Apparatus 110 was installed into the test rig by an independent lab as shown in Scheme 1 below:

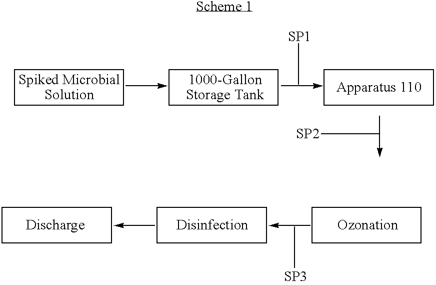

Base water (charcoal filtered potable city water) was prepared for each test. A spiked microbial solution (microbe and bromide) was added to the base water in preparation for the test. Untreated spiked base water samples were taken at sample point 1 (SP1). Apparatus 110 was started up and the spiked challenge water flowed through the Apparatus 110. Samples were taken at sample point 2 (SP2) to measure the impact of the Apparatus 110 on the microbes and measure bromate formation. A small amount of ozone was added to the next step (less than 0.02 ppm). Samples were taken at sample point 3 (SP3). Water was stored for final disinfection (chlorine solution added) before final discharge.

The U.S. Environmental Protection Agency has developed a protocol for testing point-of-use and point-of-entry device testing. The protocol describes the composition of the base water for use in the tests. This is the same base water that was used to define the water for this test. The characteristics for this base water are below:

a) Chlorine free

b) pH-6.5-8.5

c) TOC-0.1-5.0 mg/L

d) Turbidity-0.1-5 NTU

e) Temperature-20° C.±5° C.

f) TDS-50-500 mg/L

The characteristics of the water used in the test are shown in Table 1:

TABLE 1

| | Cond. | TDS | | Free | TOC | Turbidity |
|---|---|---|---|---|---|---|
| | (mS) | (mg/L) | pH | Cl | (mg · L) | (NTU) |
| Day 1 Water | 0.382 | 239 | 9.46 | ND | 1.17 | 0.01 |
| Day 2 Water | 0.372 | 233 | 9.40 | ND | 2.71 | 0.01 |

Note that the water was in range for chlorine (not detected, ND), total organic carbon (TOC) and TDS. The turbidity value is reflective of the lower detection level of the independent laboratory. The water was slightly out of range for pH (9.43 averages) and temperature (27° C). However, none of these characteristics would significantly change the results of the test nor could they not be corrected in any further tests.

Apparatus 110 was operated with a water flow of 22-25 gallons per minute. This value approaches commercial flow rates. In fact, this higher flow rate resulted in ozone concentrations lower than the target level of 0.05 ppm. The other settings of apparatus 110 are held proprietary by Applicant's assignee.

Commercial PET containers and closures were used to take samples at each sample point and appropriate sample times. Additional samples were taken in sterile microbiological sample containers containing sodium thiosulfate as the preservative. This preservative inhibits any action of oxidants (e.g. chlorine, ozone or peroxide) toward any microbes present. Samples were taken at the start-of-run (SOR), 15 minutes after SOR, 30 minutes after SOR and end-of-run (EOR). A higher flow rate for the first test resulted in only 3 sets of samples taken. The 30 minute sample and the EOR sample are the same.

Microbiological Test Protocol

The two microbial spiked solutions were prepared 2-3 days in advance of the test. The target concentration of the spiked solutions was on the order of 1 billion colony forming units per milliliter (10⁹ cfu/ml). This would have resulted in the challenge water containing on the order of 1 million (10⁶) cfu/ml. This level was not reached. A level greater than 10⁴ cfu/ml was attained.

Results

Bromide/Bromate

The bromate results are shown in Tables 2 and 3 below. The units of the results are mg/L (or ppm). Note the allowable level of bromate in water (US and Canada) is 0.010 mg/L.

TABLE 2

| Day 1 | Bromide Content (spiked base water) | | | 0.122 |
|---|---|---|---|---|
| | Bromate Content (mg/L) | | | |
| | SOR | 15 | 30 | EOR |
| SP1 | 0.000 | | | |
| SP2 | 0.010 | 0.007 | 0.004 | |
| SP3 | 0.010 | 0.010 | 0.004 | |

TABLE 3

| Day 2 | Bromide Content (spiked base water) | | | 0.122 |
|---|---|---|---|---|
| | Bromate Content (mg/L) | | | |
| | SOR | 15 | 30 | EOR |
| SP1 | 0.000 | | | |
| SP2 | 0.002 | 0.005 | 0.009 | 0.009 |
| SP3 | 0.010 | 0.008 | 0.01 | 0.008 |

The results indicate that a small amount of bromide was converted (maximum bromate concentration of 0.010 ppm) on either day of testing. This is an extremely low level of bromide conversion to bromate relative to the concentration of bromide in the challenge water. Although there is a regulated maximum allowable level of bromate in water of 0.010 ppm, bromide concentrations in water are typically less than 0.010 ppm. Most source waters for bottled water contain far less than 0.120 ppm of bromide. Therefore, it would be expected that water processed by apparatus 110 would not produce bromate anywhere near the maximum allowable level when the feed water contains 0.010 ppm of bromide.

Pseudomonas fluorescens

The disinfection results of the challenge water containing Pseudomonas fluorescens (PF) were rather encouraging for a viability test. PF concentrations are shown in the tables below.

TABLE 4

| Test | Day 0 | | | SOR (Sterile | EOR(Sterile |
|---|---|---|---|---|---|
| Point | SOR | 15 | 30 | Container) | Container) |
| SP1 | 1.80E+04 | 1.80E+04 | 1.80E+04 | 1.60E+04 | 1.00E+05 |
| SP2 | 0.00E+00 | 0.00E+00 | 1.00E+02 | No Data | 4.00E+03 |
| SP3 | 0.00E+00 | 0.00E+00 | 0.00E+00 | 1.00E+02 | 4.00E+03 |

TABLE 5

Day 3

| Test | | 30 (Sterile |
|---|---|---|
| Point | 30 | Container) |
| SP1 | 1.00E+05 | 1.00E+05 |
| SP2 | 0.00E+00 | 1.00E+05 |
| SP3 | 0.00E+00 | 1.00E+04 |

TABLE 6

Day 10

| Test | | 30 (Sterile |
|---|---|---|
| Point | 30 | Container) |
| SP1 | 1.00E+07 | 7.00E+03 |
| SP2 | 0.00E+00 | 3.20E+03 |
| SP3 | 2.00E+03 | 3.20E+03 |

The first table contains the results of testing at each sample point and each test time for the first day the test was conducted. The next two tables contain the results of sample regrowth after the 30 minute samples (taken 30 minutes after SOR) were held for 3-days and 10 days. The 3-day data indicates no regrowth for the samples taken in PET containers. There is a small amount of regrowth at 10-days for the sample that was ozonated.

Note, samples taken in the sterile containers with the preservative showed growth and regrowth for all samples taken. This will be discussed below.

The results indicate that apparatus 110 in general reduced the PF to nearly zero. This could be considered a 4-log reduction for the product water sampled in PET containers. These are bottled water industry standard bottles. Note these bottles were filled with 50 ppm chlorinated water overnight before the test to disinfect the bottles. The water was removed the morning of the test and the bottles allowed to air out. This process resulted in dissipation of any residual chlorine.

E. coli

A similar test was conducted. The challenge water contained 0.132 ppm of bromide and spiked with E. Coli. The results of the microbiological disinfection are below.

TABLE 7

| Test | Day 0 | | | SOR (Sterile | EOR(Sterile |
|---|---|---|---|---|---|
| Point | SOR | 15 | 30 | Container) | Container) |
| SP1 | 3.00E+04 | 3.20E+04 | 5.00E+04 | 5.00E+04 | 1.00E+05 |
| SP2 | 2.00E+03 | 0.00E+00 | 1.00E+02 | No Data | 1.00E+04 |
| SP3 | 0.00E+00 | 0.00E+00 | 0.00E+00 | 1.00E+02 | 3.00E+04 |

TABLE 8

Day 3

| Test | | 30 (Sterile |
|---|---|---|
| Point | 30 | Container) |
| SP1 | 1.00E+07 | 1.00E+07 |
| SP2 | 0.00E+00 | 1.00E+07 |
| SP3 | 0.00E+00 | 1.00E+06 |

TABLE 9

Day 10

| Test | | 30 (Sterile |
|---|---|---|
| Point | 30 | Container) |
| SP1 | 1.00E+07 | 9.00E+04 |
| SP2 | 0.00E+00 | 6.40E+03 |
| SP3 | 0.00E+00 | 1.00E+07 |

The first table contains the results of testing at each sample point and each test time for the second day (E. coli) the test was conducted. The next two tables contain the results of sample regrowth after the 30 minute samples (taken 30 minutes after SOR) were held for 3-days and 10 days. The 3-day data indicates no regrowth for the samples taken in PET containers for 3-days and 10-days.

Note, samples taken in the sterile containers with the preservative showed growth and regrowth for all samples taken. This will be discussed below.

The results indicate that apparatus 110 in general reduced the E.coli to nearly zero. This could be considered a 4-log reduction for the product water sampled in PET containers.

The water bottled in PET containers, which did not contain a preservative, showed no regrowth at either the 3-day or 10-day post bottling times for either Pseudomonas fluorescens or E. coli. Bottling in PET containers is representative of the conditions under which the water would be commercially bottled. These are positive results indicating that the process of the present invention killed the Pseudomonas fluorescens and E. coli. Consistent results were obtained in the two tests.

Parallel samples taken in standard, sterile plastic microbiological sample containers showed some growth. These sample containers contain the preservative, sodium thiosulfate, which removes free chlorine or any oxidant (e.g. ozone and peroxide) from samples. The effect that the preservative, sodium thiosulfate, may have had on the microbe killing mechanism generated by the process disclosed in the invention is not known.

The entire teachings of the following documents are herein incorporated by reference: U.S. Pat. No.: 6,217,712 B1, granted Apr. 17, 2001; U.S. application No.: 09/679,371 (abandoned), filed Oct. 5, 2000; U.S. application No.: 09/507,122, filed Feb. 18, 2000; U.S. Pat. No.: 6,217,712, granted Mar. 29, 2001; U.S. application No.: 08/760,342 (abandoned), filed Dec. 4, 1996; and U.S. application No.: 11/209,176 filed Aug. 22, 2005.

While this invention has been particularly shown and described with references to preferred embodiments thereof, it will be understood by those skilled in the art that various changes in form and details may be made therein without departing from the scope of the invention encompassed herein.

What is claimed is:

1. A apparatus for sanitizing water, comprising:
a) a pump;
b) a plurality of cells, wherein each cell comprises:
i) an inlet and an outlet for a flow of water;
ii) an electrically-conductive tubing housed in the cell and connecting the inlet with the outlet; and
iii) an electromagnetic pulsing device connected to the tubing;
c) a conduit system connecting the plurality of the cells with each other and with the pump; and
d) a valve system at the conduit system for directing the flow of water through the conduit system.

2. The apparatus of claim 1, wherein the electrical pulsing device comprises: an electrically-conductive insert connected to the tubing; and a plurality of electromagnetic plates connected to the electrically-conductive insert.

3. The apparatus of claim 2, wherein the electrically-conductive insert includes a plurality of ribs for accommodating the electromagnetic plates.

4. The apparatus of claim 2, wherein the electrically-conductive insert comprises a first half section and a second half section, the first half section being anodic and the second half section being cathodic.

5. The apparatus of claim 2, wherein the electromagnetic plates are formed of titanium.

6. The apparatus of claim 2, wherein the electromagnetic plates are formed of titanium and platinum.

7. The apparatus of claim 2, wherein a first half of the plurality of the electromagnetic plates are anodic and a second half of the plurality of the electromagnetic plates are cathodic.

8. The apparatus of claim 2, wherein the electric pulsing device include a multi-tap isolation transformer for removing harmonics.

9. The apparatus of claim 8, wherein the transformer is a three-phase multi-tap isolation transformer.

10. The apparatus of claim 8, wherein the electric pulsing device further include a resistor, and a phase-lock loop.

11. The apparatus of claim 10, wherein the resistor is a thyrister and the phase-lock loop is digital.

12. The apparatus of claim 1 further comprising a control for controlling the electrical pulsing device.

13. The apparatus of claim 1 further comprising a control for controlling the pump and the valve system.

14. The apparatus of claim 1, wherein the valve system directs flow through the cells in a series mode.

15. The apparatus of claim 1, wherein the valve system directs flow through the cells in a series-parallel mode.

16. A method of sanitizing water, comprising the steps of:
a) introducing a flow of water to a sanitizing apparatus;
b) actuating the sanitizing apparatus to administer electromagnetic pulses; and
c) exposing the flow of water to the electromagnetic pulses.

17. The method of claim 16, wherein the sanitizing apparatus comprises:
a) a pump;
b) a plurality of cells, wherein each cell comprises:
i) an inlet and an outlet for a flow of water;
ii) an electrically-conductive tubing housed in the cells and connecting the inlet and the outlet; and
iii) an electromagnetic pulsing device connected to the tubing;
c) a conduit system connecting the plurality of the cells with each other and with the pump; and
d) a valve system at the conduit system for directing the flow of water through the conduit system.

18. The method of claim 17, wherein the valve system directs flow through the cells in a series mode.

19. The apparatus of claim 17 wherein the valve system directs flow through the cells in a series-parallel mode.
